(19) United States
(12) Patent Application Publication
(10) Pub. No.: US 2008/0273002 A1
(43) Pub. Date: Nov. 6, 2008

(54) DRIVING CHIP AND DISPLAY APPARATUS HAVING THE SAME

(75) Inventors: Bora KIM, Seoul (KR); Sun Kyu SON, Suwon-si (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-Si (KR)

(21) Appl. No.: 12/035,951

(22) Filed: Feb. 22, 2008

(30) Foreign Application Priority Data
May 2, 2007 (KR) 10-2007-0042710

(51) Int. Cl. G09G 3/36

(52) U.S. Cl. 345/98

(57) ABSTRACT

A driving chip and a display apparatus having the same. The driving chip includes a plurality of driving circuits which generate a driving signal, a plurality of output pads which output the driving signals to external signal lines, a plurality of connection lines which connect the plurality of driving circuits and the plurality of output pads, respectively, wherein at least one of the plurality of connection lines includes a resistance-control unit which controls resistance values of the connection lines to be the same, and reduces a resistance deviation between the connection lines.

Thus, resistances of connection lines are controlled to be substantially the same, or resistance deviation is reduced by adjusting the resistances of the respective connection lines of an output port. Accordingly, a signal delay or a signal distortion induced by the resistance deviation of the connection lines in the driving chip is prevented, and defective images are removed.

This application claims priority to Korean Patent Application No. 10-2007-0042710 filed on May 2, 2007, and all the benefits accruing therefrom under 35 U.S.C. §119, the contents of which in its entirety are herein incorporated by reference.

### BACKGROUND OF THE INVENTION

1. Field of the Invention

The invention relates to a driving chip and a display apparatus having the same, and more particularly, to a driving chip supplying a driving signal to a unit pixel and a display apparatus having the same.

2. Description of the Related Art

A liquid crystal display (“LCD”) displays an image by controlling a transmitted amount of light incident from a light source using optical anisotropy of liquid crystal molecules and polarization characteristic of polarizer. Recently, the application scope of LCDs is widely expanding because lightweight, slim size, high resolution, and a large screen size can be implemented in LCDs as well having low power consumption.

The LCD includes a liquid crystal display panel having an upper substrate including a color filter and a common electrode, a lower substrate including a thin film transistor and a pixel electrode, and a liquid crystal layer interposed between the upper and the lower substrate. In addition, a backlight is provided below the liquid crystal display panel as a light source. Further, polarizers are attached to both sides of the liquid crystal display panel to control the transmittance of light incident from the backlight with the liquid crystal layer. Further, a plurality of driving chips which control a unit cell is mounted on a part of regions of the liquid crystal display panel.

Conventionally, a driving chip includes a large number of circuits integrated in a small area. The large number of circuits includes a driving circuit which generates a driving signal, and an output pad which outputs the driving signal. Since it is difficult to form all connection lines connecting the driving circuits and output pads to have the same length and the same configuration, resistance deviation is observed between the connection lines depending on their locations in the driving chip. Due to the resistance deviation between the connection lines, the driving signals which are generated from the driving chip and supplied to a unit cell, are delayed or distorted, causing defective images such as a vertical line-defect to be displayed. Even though the same pattern signal is supplied to a liquid crystal display panel, the vertical line-defect is displayed due to the resistance deviation between the connection lines. That is, pixels connected to a central region of the driving chip output more white grayscales than a targeted value, and pixels connected to side regions of the driving chip output more black grayscales than the targeted value, to display vertical line-defects.

### BRIEF SUMMARY OF THE INVENTION

The present invention has made an effort to solve the above stated problems, and aspects of the present invention provides a driving chip in which connection lines of output terminals have substantially the same resistance and a display having the same.

Another aspect of the present invention provides a driving chip having a small resistance deviation between connection lines of output terminals and a display having the same is provided.

Further, another aspect of the present invention provides: a driving chip to prevent a delay or distortion of a driving signal by forming connection lines to substantially have the same resistance of output terminals or by reducing a resistance deviation between the connection lines at output terminals in order to improve a display quality; and a display having the same is provided.

In an exemplary embodiment, the present invention provides a driving chip which includes a plurality of driving circuits which generate driving signals, a plurality of output pads which output the driving signals to external signal lines, and a plurality of connection lines which connect the plurality of driving circuits and the plurality of output pads, respectively. Further, at least one of the plurality of connection lines includes a resistance-control unit which controls resistance values of the respective connection lines so as to be equal to each other, and which reduces a resistance deviation between the connection lines.

According to an exemplary embodiment, the resistance-control unit controls at least one of a length of each connection line, a linewidth, the number of contacts formed on each connection line, and combinations thereof.

According to an exemplary embodiment, the length of each connection line may be controlled depending on a shape of the connection line. Further, the shape of the connection line may be one of a zigzag type, rectangular sawtooth type, a wave type, a triangular sawtooth type, and combinations thereof.

According to an exemplary embodiment, the linewidth of the connection line may be increased when a resistance of the line is larger than a targeted resistance, and decreased when the resistance of the line is smaller than the targeted resistance.

According to an exemplary embodiment, the number of contacts may be decreased when a resistance of the line is larger than a targeted resistance, and increased when the resistance of the line is smaller than the targeted resistance.

According to an exemplary embodiment, the resistance deviation may be ±10% of the targeted resistance.

According to an exemplary embodiment, the targeted resistance may be in a range of approximately 250-350Ω.

According to another exemplary embodiment, the present invention provides a display which includes a display panel including a plurality of pixels and a plurality of signal lines connected to the plurality of pixels, and a driving chip including a plurality of driving circuits generating driving signals which control the plurality of pixels, a plurality of output pads which output the driving signals to the plurality of signal lines, and a plurality of connection lines which connect the plurality of driving circuits and the plurality of output pads, respectively. Further, at least one of the plurality of connection lines includes a resistance-control unit which controls resistance values of the respective connection lines to be equal to each other, and which reduces a resistance deviation between the connection lines.

According to an exemplary embodiment, the plurality of driving chips may output data signals to the plurality of signal lines.

According to an exemplary embodiment, the plurality of driving chips further include a charge share circuit which precharges the data signal, and an antistatic protection circuit which prevents static electricity. The charge share circuit and the antistatic protection circuit may be disposed between the driving circuit and the output pad, and connected by the connection lines.

According to an exemplary embodiment, one or both of the charge share circuit and the antistatic protection circuit may be the resistance-control unit of the connection lines.

According to an exemplary embodiment, the resistance-control unit may control at least one of a length of each connection line, a linewidth, the number of contact formed on each connection line, and combinations thereof.

According to an exemplary embodiment, the resistance-control unit may control the resistances of the respective connection lines to be in a range of approximately 250-350Ω.

According to an exemplary embodiment, the resistance-control unit may control the resistance deviation of the respective connection lines to be ±10% of the targeted resistance.

According to an exemplary embodiment, the display panel may include a liquid crystal display panel.

According to another exemplary embodiment, the present invention provides a display which includes a display panel including a plurality of pixels and a plurality of signal lines connected to the plurality of pixels, and a plurality of driving chips which supply driving signals to the respective signal lines. Further, each driving chip is includes a resistance-control unit which adjusts a resistance distribution of connection lines of the output terminals so as to be uniform among the respective driving chips.

According to another exemplary embodiment, the resistance-control unit controls resistances of the internal lines of the output port to be the same, and reduces a resistance deviation of the internal lines of the output port.

According to another exemplary embodiment, the resistance-control unit controls at least one of a length of each internal line, a linewidth, the number of contacts, and combinations thereof.

### BRIEF DESCRIPTION OF THE DRAWINGS

The above and/or other aspects, features and advantages of the present invention will become more apparent from the following detailed description when taken in conjunction with the accompanying drawings, in which:

FIG. 1 is a block diagram illustrating an exemplary embodiment of a liquid crystal display according to the present invention;

FIG. 2 is a circuit diagram illustrating an exemplary embodiment of a data driving chip according to the present invention;

FIG. 3 is a block diagram illustrating an exemplary embodiment of a driving circuit of the data driving chip according to the present invention;

FIG. 4 is a schematic diagram illustrating an exemplary embodiment of an arrangement of the data driving chip according to the present invention;

FIGS. 5A and 5B are schematic diagrams illustrating an exemplary embodiment of connection lines of some driving circuits in the data driving chip shown in FIG. 4, according to the present invention;

FIGS. 6A and 6B are schematic diagrams illustrating an exemplary embodiment of connection lines of some driving circuits in a data driving chip according to the present invention;

FIGS. 7A and 7B are schematic diagrams illustrating another exemplary embodiment of connection lines of some driving circuits in a data driving chip according to the present invention;

FIGS. 8A and 8B are graphs illustrating an exemplary embodiment of resistance values of the connection lines in the data driving chip according to the present invention.

### DETAILED DESCRIPTION OF THE INVENTION

The present invention will now be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “lower” other elements or features would then be oriented “above” or “upper” relative to the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be described in detail with reference to the accompanying drawings.

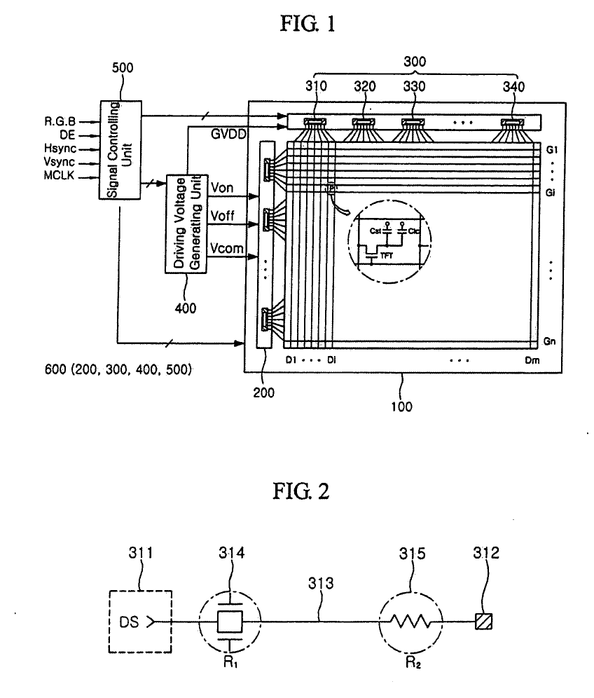

FIG. 1 is a block diagram illustrating an exemplary embodiment of a liquid crystal display according to the present invention.

Referring to FIG. 1, a liquid crystal display according to an exemplary embodiment of the present invention includes a liquid crystal display panel 100 comprising a plurality of pixels arranged in a form of matrix, and a liquid crystal driving circuit 600 which controls an operation of the pixels.

The liquid crystal display panel 100 comprises a plurality of gate lines G1 to Gn extending in one direction, a plurality of data lines D1 to Dm extending in another direction which intersects the gate lines, and a plurality of unit pixels P disposed at the intersections. Each unit pixel P comprises a thin film transistor TFT, a liquid crystal capacitor Clc and a storage capacitor Cst.

A gate terminal of each thin film transistor TFT is connected to the gate lines G1 to Gn, a source terminal is connected to the data lines D1 to Dm, and a drain terminal is connected to a pixel electrodes (not shown) of the liquid crystal capacitor Clc. The thin film transistor TFT operates according to a gate turn-on voltage Von supplied to the gate line G1 to Gn, and supplies a data signal of the data lines D1 to Dm to the liquid crystal capacitor Clc and the storage capacitor Cst. The liquid crystal capacitor C c is formed to include a liquid crystal layer as a dielectric layer between a pixel electrode and a common electrode facing each other.

When the thin film transistor TFT is turned on, the data signal DS is charged in the liquid crystal capacitor Clc to control the arrangement of the liquid crystal molecules. The storage capacitor Cst includes a protection layer as a dielectric layer between a pixel electrode and a storage electrode facing each other. The storage capacitor Cst stably preserves the data signal charged in the liquid crystal capacitor Clc until the next signal is charged. According to an exemplary embodiment, the storage capacitor Cst, which assists the liquid crystal capacitor Clc, may be omitted. Meanwhile, according to an exemplary embodiment, each unit cell may display one of the three primary colors (red, green and blue). Accordingly, a color filter (not shown) is included in each pixel, and a black matrix (not shown) is provided between each pixel region to prevent leakage of light.

According to an exemplary embodiment, the liquid crystal driving circuit 600 includes a driving voltage generating unit 400, a gate driving unit 200, a data driving unit 300, and a signal controlling unit 500 which controls these units outside the liquid crystal display panel 100. The liquid crystal driving unit 600 supplies various control signals to operate the liquid crystal display panel 100.

According to an exemplary embodiment, the gate driving unit 200 and the data driving unit 300 may be directly formed on a lower substrate of the liquid crystal display panel 100 (amorphous silicon gate “ASG” method), or may be separately manufactured to be mounted on the lower substrate by a process such as chip on board (“COB”) method, tape automated bonding (“TAB”) method, or chip on glass (“COG”) method. According to an exemplary embodiment, the gate driving unit 200 and the data driving unit 300 may be manufactured as at least one chip so as to be mounted on the lower substrate. The driving voltage generating unit 400 and the signal controlling unit 500 may be mounted on a printed circuit board (“PCB”), and connected to the gate driving unit 200 and the data driving unit 300 by a flexible printed circuit (“FPC”), so that they are electrically connected to the liquid crystal display panel 100.

The signal controlling unit 500 is supplied with an input image signal and input control signal from an external graphic controller (not shown). For example, the signal controlling unit 500 is supplied with an input image signal including an image signal (R, G and B), and an input control signal including a vertical synchronization signal Vsync, a horizontal synchronization signal Hsync, a main clock MCLK, and a data enable signal DE.

In addition, the signal controlling unit 500 generates internal image data (R, G and B) by processing the input image signal to be suitable for an operational condition of the liquid crystal display panel 100. Then, the signal controlling unit 500 generates a gate control signal and a data control signal. The gate control signal is transmitted to the gate driving unit 200, and the image data (R, G and B) and the data control signal are transmitted to the data driving unit 300 by the signal controlling unit 500. The image data (R, G and B) is rearranged according to a pixel arrangement of the liquid crystal display panel 100, and corrected by an image correction circuit (not shown). Further, the gate control signal includes a vertical synchronization start signal STV which instructs the start of the output of the gate on voltage Von, a gate clock signal CPV; and an output enable signal OE. The data control signal comprises a horizontal synchronization start signal STH which indicates the start of transmission of the image data, a load signal LOAD which instructs the supply of the data signal to a corresponding data line, an inversion signal RVS which reverses a polarity of a gray scale voltage with respect to a common voltage, and a data clock signal DCLK.

A driving voltage generating unit 400 generates and outputs various driving voltages required for driving the liquid crystal display panel 100 by using external power which is input from an external power supply (not shown). For example, by the driving voltage generating unit 400, a gate off voltage Voff which turns off the thin film transistor TFT is generated and output to the gate driving unit 200, a gamma reference voltage GVDD is generated and output to the data driving unit 300, and a common voltage Vcom is generated and output to the liquid crystal capacitor Clc and the storage capacitor Cst.

The gate driving unit 200 starts operation according to the vertical synchronization start signal STV. In addition, the gate driving unit 200 is synchronized by the gate clock signal CPV, and sequentially outputs the gate signals as analog signals to the plurality of gate lines G1 to Gm disposed on the liquid crystal display panel 100. The gate signals of an analog-type as described above including the gate on voltage Von and the gate off voltage Voff etc., are input from the driving voltage generating unit 400. Further, the gate on voltage Von may be output during a high period of the gate clock signal CPV, and the gate off voltage Voff may be output during a low period of the gate clock signal CPV.

The data driving unit 300 generates a gray scale voltage using the gamma reference voltage GVDD of the driving voltage generating unit 400. In addition, the data driving unit 300 converts the input image data which are digital signals into data signals DS which are analog signals using the gray scale voltage, and then supplies the data signal DS to a corresponding data line D1 to Dm. The data driving unit 300 includes at least one data driving chips 310 through 340 which supplies the data signals DS to the respective data lines D1 to Dm.

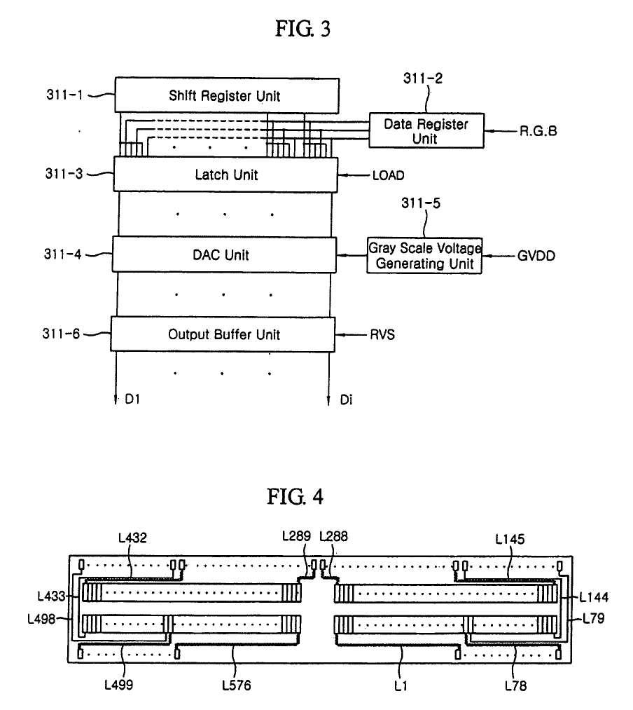

FIG. 2 is a circuit diagram illustrating an exemplary embodiment of the data driving chip according to the present invention, and FIG. 3 is a block diagram illustrating an exemplary embodiment of a driving circuit of the data driving chip according to the present invention.

Referring to FIG. 2, the data driving chip 310 includes a driving circuit 311 which generates a data signal DS, an output pad 312 which outputs the data signal DS to a data line, and a connection line 313 which electrically connects the driving circuit 311 and the output pad 312. According to an exemplary embodiment, the data driving chip 310 may further include a charge share circuit 314 which precharges the data signal DS, and an antistatic protection circuit 315 which prevents static electricity. According to an exemplary embodiment, the charge share circuit 314 and the antistatic protection circuit 315 may be disposed between the driving circuit 311 and the output pad 312, and connected by the connection line 313. The charge share circuit 314 supplies a predetermined level of voltage to the data line D1 to Dm before supplying the data signal DS, and therefore, reduces a swing amplitude of the data signal DS having a changeable polarity. The antistatic protection circuit 315 includes a static-electricity prevention element such as a Zener diode, and prevents damage and malfunction of the driving circuit 311 caused by static electricity from the inside or outside. The charge share circuit 314 and the antistatic protection circuit 315 include resistance components R1 and R2 respectively. According to an exemplary embodiment, the R1 and R2 can be adjusted in a predetermined range according to a circuit configuration. That is, at least one of the charge share circuit 314 and the antistatic protection circuit 315 may be a resistance-control unit as described below.

Referring to FIG. 3, the driving circuit 311 includes a shift register unit 311-1 which samples an input data and generates a sampling signal, a data register unit 311-2 which temporarily stores image data (R, G and B), a latch unit 311-3 which latches the image data for one line and outputs them at the same time in response to the sampling signal, a gray scale voltage generating unit 311-5 which generates a plurality of gray scale voltages, a digital-analog converter (“DAC”) unit 311-4 which converts the image data which are digital signals into data signals which are analog signals using the gray scale voltage, an output buffer unit which outputs the data signals to data lines D1 to Dm. According to an exemplary embodiment, the gray scale voltage generating unit 311-5 may be provided outside the data driving unit 300 as a separate module.

The driving circuit 311 having such a configuration operates as follows. The shift register unit 311-1 generates the sampling signals based on a control signal provided from the signal control unit 500, and supplies the sampling signals to the latch unit 311-3. That is, the shift register unit 311-1 starts operation according to the horizontal synchronization start signal STH which indicates the start of the input of image data for one line. Then, the shift register unit 311-1 generates the sampling signals synchronized with the data clock signal DCLK, and outputs them. The data register unit 311-2 temporarily stores the image data (R, G and B) sequentially input from the signal control unit 500. The latch unit 311-3 samples and latches the image data (R, G and B) which are temporarily stored in the data register unit 311-2 in response to the sampling signal of the shift register unit 311-1. The latch unit 311-3 latches image data for one line in response to the sampling signal, and outputs them at the same time according to the load LOAD signal. The gray scale voltage generating unit 311-5 divides the gamma reference voltage GVDD to gray scale voltages having a plurality of voltage levels by a voltage dividing means, and supplies them to the DAC unit 311-4. The number of levels of the gray scale voltages depends on a bit number of the image data (R, G and B). For example, when the image data is 8 bits, the gray scale voltages includes 256 levels. The DAC unit 311-4 converts the image data into data signals which are analog signals using a gray scale voltage, which is selected in response to the image data (R, G and B), and outputs them as data signals DS. Then an output buffer unit 311-6 amplifies the data signals to a predetermined value, and supplies them to the respective data lines D1 to Di. In the current exemplary embodiment, the gray scale voltage generating unit 311-5 generates a pair of gray scale voltages having different polarities i.e., positive/negative polarities according to a polarity inversion signal, and then supplies them to the DAC unit 311-4. Accordingly, data signals DS having positive or negative polarity are supplied to pixels by a frame inversion method, a line inversion method, or dot inversion method. The inversion driving method may increase power consumption and heat generation during operation due to a large swing amplitude, the swing amplitude being required to be reduced. The swing amplitude of the voltage of the data driving chip 310 can be reduced by applying a predetermined voltage to the corresponding data line before applying the data signal, which is a precharging method.

Typically, a large number of driving circuits and output pads are integrated in a small area in the data driving chip. For example, a data driving chip of 8 bits-576 channels processes data signals of 8 bits, and provided with 576 driving circuits and output pads to supply data signals DS to 576 data lines D1 to D576, respectively. Due to spatial limitation, it is difficult to form all connection lines connecting the driving circuits and output pads to have the same length. Therefore, resistance deviation may appear between the connection lines within a data driving chip 310, and defective images such as a vertical line-defect can be displayed. However, defective images due to the resistance deviation between the connection lines are minimized in the data driving chip 310 according to an exemplary embodiment of the present invention. That is, the resistances of the connection lines is controlled to have substantially the same values or be in a targeted range of resistance by controlling at least one of a length of the connection line 313, a linewidth, and the number of contacts in the driving chip 310 according to the exemplary embodiment of the present invention. Hereinafter, controlling the resistance values to be substantially the same or in a targeted range will be described in more detail based on the exemplary embodiment and modification. In addition, since a data driving chip 310 of a liquid crystal display shows an excellent operational characteristic when resistances of connection lines are in a range of approximately 250-350Ω, the targeted range of resistance is set at approximately 250-350Ω in the following exemplary embodiment. When a targeted resistance is specified, for example, when the targeted resistance is approximately 300Ω, the resistances of connection lines may be controlled to be in a range of 300Ω±10%. That is, the appropriate resistance deviation may be ±10%. The targeted resistance and the resistance deviation may vary according to the need of data driving chip 310.

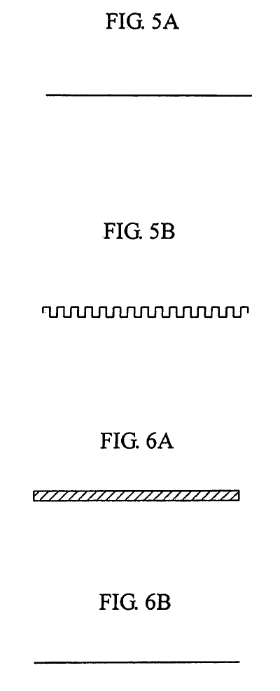

FIG. 4 is a schematic diagram illustrating an exemplary embodiment of an arrangement of the data driving chip according to the FIGS. 5A and 5B are schematic diagrams illustrating an exemplary embodiment of connection lines of some driving circuits in the data driving chip shown in FIG. 4, according to the present invention.

Referring to FIG. 4, driving circuits 311 are disposed at four locations in a central region, and output pads 312 are disposed at both sides of an outer region of the data driving chip 310 according to the current exemplary embodiment. In this configuration, for example, L79th to L144th connection lines and L433rd through L498th are connected to output pads 312 detouring around the central region in which the driving circuits 311 are disposed. Accordingly, a connection distance between the driving circuit 311 and the output pad 312 is long, so that the resistance of each connection line is larger than the targeted value. Meanwhile, L145th through L288th connection lines and L289th through L432nd connection lines are connected to output pads in an adjacent region. Accordingly, the connection distance between the driving circuit 311 and the output pad 312 is short, so that the resistance of each connection line is smaller than the targeted value. Therefore, as shown in FIG. 5A, the connection lines having larger resistances than a targeted value, for example, L79th through L144th connection lines and L433rd through L498th connection lines, are formed to have a straight line shape. Therefore, the lengths of the connection lines can be minimized to reduce the resistance of the lines. Meanwhile, as shown in FIG. 5B, the connection lines having smaller resistances than a targeted value, for example, L145th through L288th connection lines and L289th to L432nd connection lines, are formed to have a zigzag shape as same as a rectangular sawteeth. Therefore, the lengths of the connection lines can be increased to increase the resistance of the lines. The length of the line can be controlled by a distance between the rectangular sawteeth. According to an exemplary embodiment, the shape of the connection lines L145 through L288 and L289 through L432 is not limited to the rectangular sawtooth shape, but any modified shapes capable of controlling length can be employed. For example, a wave shape, a triangular sawtooth shape etc. can be employed. As such, the length of the lines can be adjusted by changing the shape of the respective connection lines L1 through L576 depending on the connection distance between the driving circuit 311 and the output pad 312. As a result, the resistances of the connection lines L1 through L576 can be controlled to be substantially the same, or the resistance deviation can be reduced.

FIGS. 6A and 6B are schematic diagrams illustrating an exemplary embodiment of connection lines of some driving circuits in a data driving chip according to the present invention.

A resistance of a line can be represented as R=ρL/WT, in which L is a length, W is a linewidth, T is a thickness and a resistivity is ρ. Accordingly, resistances of the connection lines L1 to L576 can be controlled to be substantially the same, or the resistance deviation can be reduced by controlling not only the length of the lines as described above but also linewidths of the lines. For example, as shown in FIG. 6A, the connection lines having larger resistances than a targeted value, i.e., L79th through L144th connection lines and L433rd through L498th connection lines, are formed to have a wide linewidth. Therefore, the resistance of the lines is reduced. Meanwhile, as shown in FIG. 6B, the connection lines having smaller resistances than a targeted value, i.e., L145th through L288th connection lines and L289th through L432nd connection lines, are formed to have a narrow linewidth. Therefore, the resistance of the lines is increased. As such, by adjusting the width of the respective connection lines L1 through L576 depending on the connection distance between the driving circuit 311 and the output pad 312, the resistances of the connection lines L1 through L576 can be controlled to be substantially the same, or the resistance deviation can be reduced.

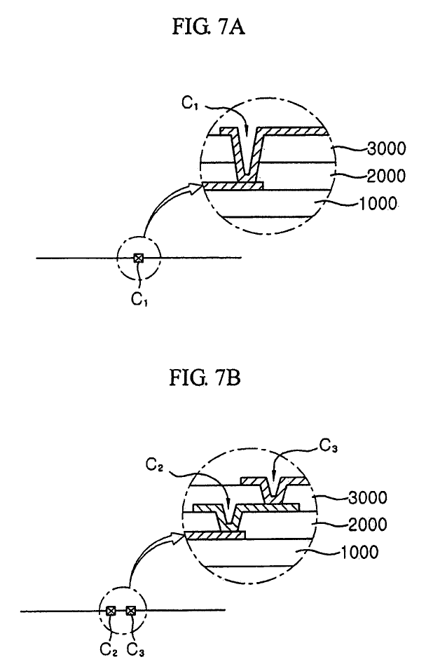

FIGS. 7A and 7B are schematic diagrams illustrating another exemplary embodiment of connection lines of some driving circuits in a data driving chip according to the present invention;

In general, a data driving chip 310 is manufactured as a multi-layered semiconductor including circuit patterns, or insulating thin films 1000 through 3000. Accordingly, connection lines L1 through L576 may also be formed on the multi-layered semiconductor or insulating thin films 1000 through 3000. The respective connection lines connected to different layers of the semiconductor or insulating thin film 1000 through 3000 are electrically connected with each other by contacts C1 through C3. These contacts C1 through C3 can be used to control the connection lines L1 through L576 to have substantially the same resistance, or reduce a resistance deviation. For example, as shown in FIG. 7A, the connection lines having larger resistances than a targeted value, i.e., L79th through L144th connection lines and L433rd through L498th connection lines, may be formed to have one contact C1. Meanwhile, as shown in FIG. 7B, the connection lines having smaller resistances than a targeted value, i.e., L145th through 288th connection lines and L289th through L432nd connection lines, are formed to have two contacts C2 and C3. A resistance of each of the contacts C1 through C3, that is, a contact resistance, is typically larger than that of the connection line. Accordingly, the difference between the resistances of the connection lines can be offset or compensated by controlling the number of the contacts. That is, by controlling the number of contacts on the respective connection lines L1 through L576, the resistances of the connection lines L1 through L576 can be controlled to be substantially the same, or the resistance deviation can be reduced.

Although the resistance-control unit which controls one of a length of a connection line, a linewidth and the number of contacts, is selected to be employed in the data driving chip 310 according to the exemplary embodiment described above, the present invention is not limited thereto. Combinations of functions of the resistance-control unit may be employed in the data driving chip 310, when it is difficult to control the resistances of the respective connection lines L1 through L576 to be the same or to be in a targeted range by employing one function of the resistance-control unit alone. The exemplary embodiment is described herein with a given circuit arrangement where the connection lines have an identical shape and an identical linewidth, and the connection lines disposed in the outer region have relatively high resistances than those disposed in the central region. However, according to an exemplary embodiment, the resistance of the respective connection lines located at a predetermined position can be variously modified according to a circuit arrangement of the driving chip 310. The resistance of the respective connection lines may be controlled regardless of the location, so that the resistances of the plurality of connection lines are substantially the same or the resistance deviation is reduced.

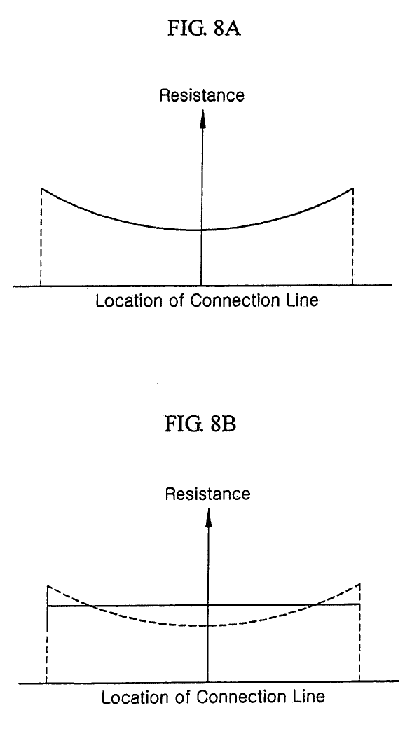

FIGS. 8A and 8B are graphs illustrating an exemplary embodiment of resistance values of the connection lines in the data driving chip 310 according to the exemplary embodiment of the present invention. The graph illustrates the resistance value depending on a location of the connection line. The central point of the horizontal axis represents the shortest connection line

A plurality of driving circuits 311 are disposed in a central region, and a plurality of output pads 312 are disposed in an outer region in a data driving chip 310. The area of the central region is relatively small, and the area of the outer region is relatively large. Accordingly, a plurality of connection lines connecting the driving circuits 311 and the output pads 312 becomes longer as the connection lines are extended from the central to the outer region, and thereby the resistances of the connection lines increase as the connection lines are extended from the central to the outer region, as shown in FIG. 8A. Therefore, the resistance of the connection lines in the central region may need to be increased, and the resistance of the connection lines in the outer region may need to be decreased in the data driving chip 310 of the exemplary embodiment. For example, the linewidth of the connection lines may need to be increased as the connection lines are extended from the central to outer region in the data driving chip of the exemplary embodiment. Thereby, the resistance deviation is reduced as shown in FIG. 8B. That is, the initial non-uniform resistance distribution shown as a dotted line is corrected to the uniform resistance distribution shown as a solid line, whereby defective images such as vertical line-defect can be suppressed.

In the exemplary embodiment described above, reducing the resistance deviation of the respective connection lines in one data driving chip 310 is described. However, it can be also applied to all data driving chips 310 through 340, to reduce the deviation of resistances of the output terminals of the respective data driving chips. Accordingly, the resistance distribution of the output terminals of the respective data driving chips can be controlled to be uniform. In addition, although reducing the resistance deviation of the respective connection lines in the data driving unit 300 is described in the exemplary embodiment described above, according to an exemplary embodiment, it can be also applied to the gate driving unit 200 to reduce the resistance deviation between the respective connection lines. The detailed description is omitted since the configuration and effect are similar to the exemplary embodiment described above. Further, although a liquid crystal display is described as an example in the exemplary embodiment above, the present invention is not limited thereto. The present invention can be applied to various display devices in which unit pixels are arranged in a matrix form and a matrix-type driving is possible, for example, a plasma display panel (“PDP”), an organic electro luminescence (“EL”) and etc.

As described above, according to an exemplary embodiment, resistances of connection lines can be controlled to be substantially the same, or resistance deviation of the connection lines of output terminals can be reduced by adjusting the resistances of the respective connection lines of an output port. Accordingly, a signal delay or a signal distortion can be prevented induced by the resistance deviation of the respective connection lines in the driving chip, and defective images such as vertical line-defect can be removed, whereby display quality of an output image can be improved.

While the present invention has been shown and described with reference to some exemplary embodiments thereof, it should be understood by those of ordinary skilled in the art that various changes in form and details may be made therein without departing from the spirit and the scope of the present invention as defined by the appending claims.

What is claimed is:

1. A driving chip comprising:
a plurality of driving circuits which generate driving signals;
a plurality of output pads which output the driving signals to external signal lines;
a plurality of connection lines which connect the plurality of driving circuits and the plurality of output pads, respectively, wherein at least one of the plurality of connection lines comprises a resistance-control unit which controls resistance values of the respective connection lines to be equal to each other, and reduces a resistance deviation between the connection lines.

2. The driving chip of claim 1, wherein the resistance-control unit controls at least one of a length of each connection line, a linewidth, a number of contacts formed on each connection line, and combinations thereof.

3. The driving chip of claim 2, wherein a length of each connection line is controlled depending on a shape of the connection line.

4. The driving chip of claim 3, wherein the shape of the connection line comprises a zigzag type having rectangular sawtooth type, a wave type, a triangular sawtooth type, and combinations thereof.

5. The driving chip of claim 2, wherein the linewidth of the connection line is increased when a resistance of the connection line is larger than a targeted resistance, and decreased when the resistance of the line is smaller than the targeted resistance.

6. The driving chip of claim 2, wherein the targeted resistance is in a range of approximately 250 to 350Ω.

7. The driving chip of claim 2, wherein the number of contacts is decreased when a resistance of the connection line is larger than a targeted resistance, and increased when the resistance of the line is smaller than the targeted resistance.

8. The driving chip of claim 6, wherein a resistance deviation is ±10% of the targeted resistance.

9. A display apparatus comprising:
a display panel comprising a plurality of pixels and a plurality of signal lines connected to the plurality of pixels; and
a driving chip comprising:
a plurality of driving circuits which generate driving signals which control the plurality of pixels,
a plurality of output pads which outputs the driving signals to the plurality of signal lines, and
a plurality of connection lines which connect the plurality of driving circuits and the plurality of output pads, respectively, wherein, at least one of the plurality of connection lines comprises a resistance-control unit which controls resistance values of the respective connection lines to be a same, or and reduces a resistance deviation between the connection lines.

10. The display apparatus of claim 9, wherein the plurality of driving chips outputs data signals to the plurality of signal lines.

11. The display apparatus of claim 10, wherein the plurality of driving chips further comprises:
a charge share circuit which precharges the data signal; and
an antistatic protection circuit which prevents static electricity, wherein the charge share circuit and the antistatic protection circuit are disposed between the driving circuit and the output pad, and connected by the connection lines.

12. The display apparatus of claim 11, wherein at least one of the charge share circuit and the antistatic protection circuit is the resistance-control unit of the connection lines.

13. The display apparatus of claim 9, wherein the resistance-control unit controls at least one of a length of each connection line, a linewidth, a number of contacts formed on each connection line, and combinations thereof.

14. The display apparatus of claim 13, wherein the resistance-control unit controls resistances of the respective connection lines to be in a range of approximately 250 to 350Ω.

15. The display apparatus of claim 13, wherein the resistance-control unit controls the resistance deviation of the respective connection lines to be ±10% of a targeted resistance.

16. The display apparatus of claim 9, wherein the display panel comprises a liquid crystal display panel.

17. The display apparatus of claim 11, wherein the charge share circuit supplies a predetermined level of voltage prior to supplying the data signals.

18. A display apparatus comprising:
a display panel comprising a plurality of pixels and a plurality of signal lines connected to the plurality of pixels; and
a plurality of driving chips which supply driving signals to the respective signal lines, wherein each driving chip comprises a resistance-control unit which adjusts a resistance distribution of output terminals to be uniform among the respective driving chips.

19. The display apparatus of claim 18, wherein the resistance-control unit controls resistances of internal lines of an output port to be a same, and reduces a resistance deviation of the internal lines of the output port.

20. The display apparatus of claim 19, wherein the resistance-control unit controls at least one a length of each internal line, a linewidth, a number of contacts, and combinations thereof.
